(19) United States
(12) Patent Application Publication
(10) Pub. No.: US 2017/0292040 A1
(43) Pub. Date: Oct. 12, 2017

(54) PRESSURE-SENSITIVE ADHESIVE

(71) Applicant: tesa SE, Norderstedt (DE)

(72) Inventors: SARAH ALEED, HAMBURG (DE); JULIA BEFUSS, NORDERSTEDT (DE); ALEXANDER PRENZEL, HAMBURG (DE); THOMAS SCHUBERT, HAMBURG (DE)

(73) Assignee: tesa SE, Norderstedt (DE)

(21) Appl. No.: 15/480,429

(22) Filed: Apr. 6, 2017

(30) Foreign Application Priority Data
Apr. 7, 2016 (DE) 10 2016 205 808.8

(51) Int. Cl. C09J 7/02

(52) U.S. Cl. CPC C09J 7/0246; C09J 7/0289; C09J 2201/128; C09J 2433/006; C09J 133/12

(57) ABSTRACT

A powerful pressure-sensitive adhesive which is notable by way of good wetting and dewetting behaviour on surfaces having different surface energies comprises at least 50 wt %, based on the total weight of the pressure-sensitive adhesive, of at least one polymer A which may be derived from the following monomer composition:
a1) 55 to 75 wt % of at least one (meth)acrylic ester having a homopolymer glass transition temperature of not more than −60° C. and an alcohol component based on a branched, primary alcohol, having an iso index of 1;
a2) 20 to 40 wt % of at least one (meth)acrylic ester having an alcohol component based on a linear C₁-C₁₈ alcohol;
a3) 5 to 15 wt % of acrylic acid.

The pressure-sensitive adhesive of the invention reveals particularly good properties when combined with a foamed carrier.

This application claims priority of German Patent Application No. 10 2016 205 808.8, filed on Apr. 7, 2016, the entire contents of which are incorporated herein by reference.

The invention pertains to the technical field of pressure-sensitive adhesives as used in single-sided and double-sided adhesive tapes. More specifically the invention relates to a pressure-sensitive adhesive based on a poly(meth)acrylate, deriving from a particular monomer composition.

One of the targets of the invention is the parameter of “wetting”, which is relevant from the technical adhesive standpoint. Wetting is understood below to refer to the development of an interface between a pressure-sensitive adhesive and the substrate to be bonded. The term “wetting” therefore describes the capacity of a pressure-sensitive adhesive to level out unevennesses and to displace air between itself and the substrate. The greater the wetting, the more effectively the interactions between pressure-sensitive adhesive and substrate are able to develop and the better, therefore, the sticking and the adhesion. A frequent observation, particularly on rough surfaces or surfaces with production-related unevennesses or curvatures or corrugations, is that wetting once achieved becomes weaker again as a result of mechanical loads—in other words, that dewetting occurs.

Wetting should be distinguished from the development of peel adhesion over time. Even when initial wetting is good, the peel adhesion may still rise over time, since increasing numbers of functional groups present in the adhesive and able to interact with the surface become oriented towards that surface.

For diverse fields of application, such as in the construction sector, in the industrial manufacture of technical products, or for assembly purposes, there is a requirement for adhesive tapes which are increasingly thick but also strongly bonding (referred to as “adhesive assembly tapes”). Since the bonds frequently take place outdoors and/or the bonded products are subject to external weathering effects, the expectations of the properties of such adhesive tapes are frequency high. Hence the bond is to be strong, durable and weather-resistant; in many cases, high moisture resistance, heat resistance and resistance to combined heat and humidity are required. The adhesives, moreover, are to rapidly wet and, in so doing, level out unevennesses in the bondline and/or on the substrates to be bonded, and to exhibit high peel adhesion from the start (initial peel adhesion). When using unfoamed adhesive tapes, a further advantage of effective wetting is that it enables transparent materials to be bonded without optical defects, as is increasingly being desired even for thick adhesive tapes (in the bonding, for instance, of transparent materials such as glasses or transparent plastics).

The adhesive tapes employed for such purposes are commonly equipped with adhesives for which the technical adhesive properties must be matched very well to one another. For instance, cohesion, initial tack, flow behaviour and other properties must be very finely tuned. Given that the technical forms of the pressure-sensitive adhesive, which influence these properties, frequently have divergent effects on the individual properties, fine tuning is generally difficult, or a compromise must be accepted in the outcome.

For very thick adhesive tapes in particular it is frequently difficult, moreover, to realize highly homogeneous adhesive tapes; as a result of processing, very thick adhesive tapes are frequently not homogeneous right through the layer. This is usually undesirable, given the frequent requirement for adhesive tapes which have well-defined properties irrespective of their layer thickness and of their production.

Substances having viscoelastic properties suitable for pressure-sensitive adhesive applications are notable in reacting to mechanical deformation both with viscous flow and with elastic resilience forces. In terms of their respective proportion, the two processes are in a certain relationship to one another, dependent not only on the precise composition, structure and degree of crosslinking of the substance in question but also on the rate and the duration of the deformation, and on the temperature.

The proportional viscous flow is necessary for achievement of adhesion. Only the viscous components, produced by macromolecules having relatively high mobility, permit effective wetting and effective flow onto the substrate to be bonded. A high proportion of viscous flow results in high intrinsic adhesiveness (also referred to as pressure-sensitive adhesiveness or as tack) and hence often also to a high peel adhesion. Highly crosslinked systems, crystalline polymers or polymers exhibiting glass-like solidification generally lack intrinsic adhesiveness, in the absence of flowable components.

The proportional elastic resilience forces are necessary for the achievement of cohesion. They are produced, for example, by very long-chain and highly entangled macromolecules, and also by physically or chemically crosslinked macromolecules, and they allow the transmission of the forces which act on an adhesive bond. They are responsible for endowing an adhesive bond with the capacity to withstand a sustained load acting on it, in the form of a long-term shearing load, for example, to a sufficient extent and over a relatively long period of time.

In foamed multi-layer adhesive tapes, a sustained load may result in uneven distribution of stress, which, if the forces are greater than the adhesion of the layer of pressure-sensitive adhesive to the surface, are manifested in partial detachment of the layer of pressure-sensitive adhesive. The proportion of the area that is wetted therefore becomes smaller.

In order to prevent the pressure-sensitive adhesives flowing off (running down) from the substrate, and to guarantee sufficient stability of the pressure-sensitive adhesive in the bonded assembly, sufficient cohesion of the pressure-sensitive adhesives is therefore necessary. For good adhesion properties, however, the pressure-sensitive adhesives must additionally be capable of flowing onto the substrate, developing interactions with the surface in the boundary layer sufficiently, and guaranteeing effective and durable wetting of the substrate surface. In order to prevent fractures within the bondline (within the layer of pressure-sensitive adhesive), moreover, a certain elasticity on the part of the pressure-sensitive adhesive is required.

To achieve sufficient cohesion on the part of the pressure-sensitive adhesives, they are generally crosslinked—that is, individual macromolecules are linked to one another by bridging bonds. Crosslinking may be accomplished in a variety of ways: there are physical and chemical (thermal) crosslinking methods, for example.

In order to produce homogeneous adhesive tapes it is an advantage to subject polymers to thermal crosslinking: it is readily possible even for thick layers to be supplied uniformly with thermal energy. Layers of adhesive crosslinked by actinic radiation (ultraviolet radiation or electron beams, for example), in contrast, exhibit a profile of crosslinking through the crosslinked layer. This crosslinking profile results from the fact that the radiation is limited in its depth of penetration into the layer, with the intensity of the radiation also decreasing in line with the depth of penetration, owing to absorption processes. Consequently, the outer regions of a radiation-crosslinked adhesive layer are crosslinked to a greater extent than the regions located more internally, with the intensity of crosslinking decreasing towards the interior overall. For thick layers in particular, this effect is very significant.

EP 2 305 389 A2 and EP 2 617 789 A1, for instance, describe thermally crosslinked, foamed and unfoamed adhesive assembly tapes having good adhesive and cohesive properties. These adhesive tapes, however, exhibit comparatively poor wetting behaviour and also, additionally, exhibit weaknesses in bonding to apolar substrates, especially to car finishes.

WO 2013/048 985 A2 and WO 2013/048 945 A1 describe multi-layer adhesive assembly tapes which are suitable in particular for bonding on apolar surfaces, especially car finishes. The adhesive tapes of WO 2013/048 985 A2 are characterized in that the outer layer of pressure-sensitive adhesive comprises (meth)acrylic esters with 2-alkylalkanol residues which have 12 to 32 carbon atoms, and optionally with C₁₋₁₂ alkanol residues. In WO 2013/048 945 A1, the outer layer of pressure-sensitive adhesive comprises, in particular, acrylic esters with a primary alcohol residue which has 14 to 25 carbon atoms and an iso index of at least 2 to not more than 4. Besides the disadvantage that the products described therein are crosslinked using UV radiation, it is found that under load, the initially good wetting deteriorates, and hence dewetting occurs.

WO 2014/081 623 A2 likewise describes UV-crosslinked multi-layer adhesive assembly tapes having very good bond strengths to car finishes. This is achieved through the use of 2-propylheptyl acrylate (PHA) as a comonomer in the outer layer of pressure-sensitive adhesive, with preferred comonomer compositions described comprising mixtures of PHA and another comonomer with an ethylenically unsaturated group. The latter comonomers are, in particular, (meth)acrylates having branched, cyclic or aromatic alcohol components, such as with isobornyl acrylate (IBOA), for example, an acrylic ester with a high glass transition temperature and a bicyclic radical.

US 2011/0244230 A1 describes an acrylate-based foam adhesive tape which is particularly conforming and is highly suitable for bonding on uneven substrates. However, the adhesive tapes described are crosslinked by UV radiation, and so the resulting crosslinking gradient results in relatively poor wetting behaviour.

EP 2 226 372 A1 describes a thermally crosslinked pressure-sensitive adhesive which comprises a polyacrylate having an acrylic acid concentration of 8 to 15 wt % and is characterized in that the ratio of the linear to the branched acrylic esters is in the range from 1:6 to 10:1 mass fractions. Nevertheless, the wetting displayed by the adhesive is too slow, as is the increase in the peel adhesion to the respective maximum peel adhesion on the substrates.

It is an object of the invention to specify powerful pressure-sensitive adhesives, especially for strongly bonding double-sided pressure-sensitive adhesive tapes. The pressure-sensitive adhesives are to provide rapid wetting of surfaces having different surface energies, examples being metals, surfaces of plastics such as PP, PE, polycarbonate, and also motor vehicle finishes, while developing a high level of adhesion. Moreover, the pressure-sensitive adhesives and the bonds produced using them are to exhibit high shear strength even at elevated temperatures, high resistance to combined heat and humidity, and high bond strength under dynamic load, the latter in particular at low temperatures. Finally, a long-lasting mechanical load on the bond is not to result in dewetting of the adhesive tape from the surface.

The achievement of the object is based on the idea of using, as principal component of the pressure-sensitive adhesive, a poly(meth)acrylate which is based substantially on a mixture of monomers having singly branched and unbranched alcohol components.

A first and general subject of the invention is a pressure-sensitive adhesive which comprises at least 50 wt %, based on the total weight of the pressure-sensitive adhesive, of at least one polymer A which may be derived from the following monomer composition:

a1) 55 to 75 wt % of at least one (meth)acrylic ester having a homopolymer glass transition temperature of not more than −60° C. and an alcohol component based on a branched, primary alcohol, having an iso index of 1;
a2) 20 to 40 wt % of at least one (meth)acrylic ester having an alcohol component based on a linear C₁-C₁₈ alcohol;
a3) 5 to 15 wt % of acrylic acid.

A pressure-sensitive adhesive of the invention is notable in particular for rapid wetting of low-energy surfaces and for high dewetting resistance even under lasting mechanical load on the bond, and also for good other technical adhesive properties.

### BRIEF DESCRIPTION OF THE DRAWINGS

The invention will now be described in greater detail with reference to the drawings, wherein:

FIG. 1 shows a device for performing at step wetting test;

FIG. 2a shows the device of FIG. 1 from above;

FIG. 2b shows the device of FIG. 1 from below; and

FIG. 3 shows an experimental unit for foaming the carrier.

A pressure-sensitive adhesive (PSA) is understood in accordance with the invention, as customary generally, as a material which in particular at room temperature is permanently tacky and also adhesive. Characteristics of a pressure-sensitive adhesive are that it can be applied by pressure to a substrate and remains adhering there, with no further definition of the pressure to be applied or the period of exposure to this pressure. In some cases, depending on the precise nature of the pressure-sensitive adhesive, the temperature, the atmospheric humidity, and the substrate, exposure to a minimal pressure of short duration, which does not go beyond gentle contact for a brief moment, is enough to achieve the adhesion effect, while in other cases a longer-term period of exposure to a high pressure may also be necessary.

Pressure-sensitive adhesives have particular, characteristic viscoelastic properties which result in the permanent tack and adhesiveness. A characteristic of these adhesives is that when they are mechanically deformed, there are processes of viscous flow and there is also development of elastic resilience forces. The two processes have a certain relationship to one another in terms of their respective proportion, in dependence not only on the precise composition, the structure and the degree of crosslinking of the pressure-sensitive adhesive but also on the rate and duration of the deformation, and on the temperature.

The proportional viscous flow is necessary for the achievement of adhesion. Only the viscous components, brought about by macromolecules with relatively high mobility, permit effective wetting and effective flow onto the substrate where bonding is to take place. A high viscous flow component results in high tack (also referred to as surface stickiness) and hence often also to a high peel adhesion. Highly crosslinked systems, crystalline polymers or polymers with glass-like solidification lack flowable components and are therefore in general devoid of tack or possess only little tack at least.

The proportional elastic resilience forces are necessary for the attainment of cohesion. They are brought about, for example, by very long-chain macromolecules with a high degree of entanglement, and also by physically or chemically crosslinked macromolecules, and they permit the transmission of the forces that act on an adhesive bond. As a result of these resilience forces, an adhesive bond is able to withstand a long-term load acting on it, in the form of a long-term shearing load, for example, sufficiently over a relatively long time period.

For the more precise description and quantification of the extent of elastic and viscous components, and also of the ratio of the components to one another, the variables of storage modulus (G′) and loss modulus (G″) can be employed, and can be determined by means of Dynamic Mechanical Analysis (DMA). G′ is a measure of the elastic component, G″ a measure of the viscous component of a substance. Both variables are dependent on the deformation frequency and the temperature.

The variables can be determined with the aid of a rheometer. In that case, for example, the material under investigation is exposed in a plate/plate arrangement to a sinusoidally oscillating shearing stress. In the case of instruments operating with shear stress control, the deformation is measured as a function of time, and the time offset of this deformation relative to the introduction of the shearing stress is measured. This time offset is referred to as phase angle δ.

The storage modulus G′ is defined as follows: G′=(τ/γ) • cos(δ) (τ=shear stress, γ=deformation, δ=phase angle=phase shift between shear stress vector and deformation vector). The definition of the loss modulus G″ is as follows: G″=(τ/γ) • sin(δ) (τ=shear stress, γ=deformation, δ=phase angle=phase shift between shear stress vector and deformation vector).

A composition is considered in general to be pressure-sensitively adhesive, and is defined in the sense of the invention as such, if at room temperature—presently, by definition, 23° C.—in the deformation frequency range from 10⁰ to 10¹ rad/sec, G′ is located at least partly in the range from 10³ to 10⁷ Pa, and G″ likewise lies at least partly in this range. “Partly” means that at least one section of the G′ curve lies within the window described by the deformation frequency range from 10⁰ inclusive up to 10¹ inclusive rad/sec (abscissa) and by the G′ value range from 10³ inclusive up to 10⁷ inclusive Pa (ordinate). For G″ this applies correspondingly.

The term “(meth) acrylic ester” is understood according to general opinion to encompass both acrylic esters and methacrylic esters. Similar comments apply in respect of the designation “(meth)acrylate”.

The iso index is a measure or, in the case of isomer mixtures, an average value for the branching of the alcohol radicals in the (meth)acrylate comonomers, and is defined as the number of methyl groups (—CH₃) in the primary alcohol minus 1 (see WO 2013/048945 A1). For determining the iso index, the free alcohol of the (meth)acrylic esters is reacted with trichloroacetyl isocyanate to form a carbamate, and a calculation is conducted in accordance with equation 1 below:

$$iso index = \frac{\frac{I ( {CH}_{3} )}{3}}{\frac{I ( {CH}_{2} - OR )}{2}} - 1 \qquad [ 1 ]$$

The degree of branching can be determined by ¹H-NMR spectroscopic analysis of the alcohol or alcohol mixture. I(CH₃) in equation 1 denotes the absolute peak area, determined by integration, of the methyl protons (δ in the range between 0.70 and 0.95 ppm), and I(CH₂—OR) denotes the absolute peak area of the methylene protons in α-position to the carbamate (δ in the range between 3.9 and 4.5 ppm) of the derivatized alcohol. An iso index of 1 means that the alcohol residue has exactly one branching point.

Preferred (meth)acrylic esters having a homopolymer glass transition temperature of not more than −60° C. and an alcohol component based on a branched, primary alcohol having an iso index of 1 are, for example, 2-propylheptyl acrylate (PHA) and isodecyl acrylate.

The PSA of the invention is preferably crosslinked thermally using at least one epoxycyclohexyl derivative in the absence of proton acceptors, electron pair donors and electron pair acceptors. Thermal crosslinking produces advantageous, homogeneous crosslinking through the entire layer of adhesive, whereas with radiation-crosslinked adhesives, for example, a crosslinking profile is observed, with a crosslinking density decreasing towards the interior of the adhesive. A homogeneously crosslinked PSA layer allows uniform distribution of stresses as may occur when the bond is subjected to loading. Adhesive and cohesive properties can be balanced very precisely for the layer as a whole, allowing robust bonds with precisely forecastable profiles of properties to be obtained. With particular preference the PSA of the invention is crosslinked thermally using at least one epoxycyclohexyl derivative in the absence of any crosslinking accelerators.

The PSA of the invention preferably comprises no peel adhesion-boosting resin. Resins commonly added to boost the peel adhesion of PSAs include, for example, aliphatic hydrocarbon resins, aromatic hydrocarbon resins, alkyl aromatic hydrocarbon resins; terpene resins, terpene-phenolic resins; rosins, especially hydrogenated, unhydrogenated and disproportionated rosins; functional hydrocarbon resins, and natural resins. The absence of peel adhesion-boosting resins is beneficial to the cohesive properties of PSAs of the invention, which are inherently very soft and conforming and exhibit high tack.

The polymer A preferably has a weight-average molecular weight M_{w} of at least 500 000 g/mol, more preferably of at least 700 000 g/mol. Likewise preferably, the polymer A has a weight-average molecular weight M_{w} of not more than 1 700 000 g/mol. The polydispersity PD, i.e. the breadth of the molar mass distribution, determined as a ratio of the weight-average molecular weight M_{w} to the number-average molecule weight Mₙ, is, for the polymer A, preferably PD 100, more preferably 20 PD 80.

In one embodiment the PSA of the invention comprises a blend of one or more polymers A and one or more synthetic rubbers. The synthetic rubber or rubbers are preferably selected from the group consisting of styrene-butadiene-styrene rubbers, styrene-isoprene-styrene rubbers and hydrogenated derivatives of the aforementioned rubbers.

A further subject of the invention is an adhesive tape which comprises a foamed carrier and a PSA of the invention. The foamed carrier preferably comprises a syntactic polymer foam. The term “syntactic foam” describes a special form of a closed-cell foam whose voids are formed by hollow glass beads, hollow ceramic beads and/or hollow polymer beads.

On the reverse of the syntactic polymer foam layer, for stabilization and/or for lining, there may be, for example, a liner or a conventional film material provided, thus giving at least one three-layer system comprising the at least two-layer adhesive tape of the invention.

Given polymer foam layers that are sufficiently thick, the side of the polymer foam layer that is facing away from the PSA layer, and that in two-layer systems is exposed, may also be stabilized by being highly crosslinked by a crosslinking operation with a low depth of penetration, so that only part of the foam carrier layer is highly crosslinked, whereas, on the other side of the carrier, facing towards the PSA layer, if anything, the viscoelastic properties originally present are retained.

With particular preference there is a PSA arranged on both sides of the foamed carrier, with one of the PSAs being a PSA of the invention. More particularly a PSA of the invention is disposed on both sides of the foamed carrier. This is advantageous since in this case, both sides of the adhesive tape have the advantageous technical adhesive properties of the PSA of the invention.

In one specific embodiment, there is a PSA disposed on both sides of the foamed carrier, and the two PSAs contain identical additives in identical concentration, more particularly functional additives and/or fillers. Similarly, both PSAs may also be free from functional additives and/or fillers. In one particular embodiment there is a PSA, more particularly a PSA of the invention, disposed on both sides of the foamed carrier, and the PSAs are identical chemically, physically and/or in their extents. More particularly, both PSAs are completely identical, leaving aside insubstantial mismatches, of the kind which may result, for example, from impurities within the realm of the omnipresent concentration, from production-related inaccuracies, and from similar other sources.

The foamed carrier preferably comprises at least 50 wt %, based on the total weight of the foam, of at least one polymer selected from the group consisting of rubbers, more particularly natural rubbers, polyurethanes, poly(meth)acrylates and styrene block copolymers, and also blends of the stated polymers. More preferably the foamed carrier contains at least 50 wt % of one or more poly(meth)acrylates, based on the total weight of the foam.

In particular the foamed carrier contains at least 50 wt %, based on the total weight of the foam, of at least one poly(meth)acrylate B which can be traced back to the following monomer composition:
b1) 65 to 97 wt % of ethylhexyl acrylate and/or butyl acrylate,
b2) 0 to 30 wt % of methylacrylate,
b3) 3 to 15 wt % of acrylic acid.

The polymer or polymers present in the foamed carrier, more preferably the polymer B, has or have a weight-average molecular weight M_{w} of at least 500 000 g/mol, more preferably of at least 700 000 g/mol. Likewise preferably, the polymers in the foamed carrier have a weight-average molecular weight M_{w} of not more than 1 700 000 g/mol. The polydispersity PD, i.e. the breadth of the molar mass distribution, which is determined as the ratio of the weight-average molecular weight M_{w} to the number-average molecular weight Mₙ, for the polymers present in the foamed carrier, is preferably 10 PD 100, more preferably 20 PD 80.

Both the polymers contained in the PSA of the invention and those contained in the foamed carrier can be prepared preferably by a free radical polymerization, preferably in solution, in accordance with the prior art. In the case of optional subsequent processing from the melt, the solvent is stripped off after the polymerization.

The foamed carrier is preferably shaped to the layer from the melt. In this case, a thermal crosslinking of the foamed layer preferably takes place. The PSAs of the invention as well may be shaped from the melt. However, given that said layers are customarily produced only in layer thicknesses of up to 100 μm, they may outstandingly also be coated from solution and dried thereafter.

In technical process terms, very thick polymer layers such as the foamed carrier layer can be produced very much more effectively from the melt (so-called hotmelts) than from the polymer solution. Regarding the definition of a melt of an amorphous polymer—such as of a polyacrylate, for example—the invention uses the criteria given in F. R. Schwarzl, Polymermechanik: Struktur and mechanisches Verhalten von Polymeren [Polymer mechanics: Structure and mechanical behaviour of polymers], Springer Verlag, Berlin, 1990, according to which the viscosity has an order of magnitude of at most η≈10⁴ Pa·s and the internal damping achieves tan δ values of ≧1.

If the polymer layers of the PSAs of the invention and of the foamed carrier of the adhesive tape of the invention are produced by coating from the melt, a problem arises which results from the preferred thermal crosslinking. On the one hand, in order to initiate subsequent thermal crosslinking, the thermal crosslinker must be added prior to coating; on the other hand, in that case, the crosslinker is exposed to the high temperatures for generating and maintaining the polymer melt. Even before the onset of controlled crosslinking, this may lead to an uncontrolled crosslinking of polymer (referred to as gelling). In order as far as possible to suppress this gelling, the hotmelt process customarily uses crosslinkers which are very slow to react, and only uses them shortly prior to coating. In order nevertheless to achieve satisfactory crosslinking outcomes after coating, moreover, what are known as “accelerators” are frequently admixed.

For polymer systems which are coated from solution and are to be crosslinked thermally as well, the use of accelerators may make sense and is frequently practised. The thermally initiated crosslinking operation is customarily associated with the thermal removal of the solvent from the applied layer (i.e. the drying of the layer of composition). Excessively rapid removal of the solvent in this case results in a poorly formed, uneven and inhomogeneous layer, owing to the fact that a drying operation which is too radical leads to blistering, for example. For this reason, drying is preferably carried out at moderate temperatures. In order nevertheless to guarantee effective crosslinking proceeding with sufficient rapidity, accelerators are customarily also added to the solvent systems.

Now coating from solution is frequently preferred when the thickness of the resulting layers is not very great, meaning that there are no significant problems associated with increased viscosity of the polymer solution to be applied (in comparison to a largely solvent-free melt).

According to the invention, the foamed carrier layer is preferably crosslinked with the aid of accelerators. As accelerators or else substance with an accelerating effect, use is made in particular of photon acceptors, electron-pair donors (Lewis bases) and/or electron-pair acceptors (Lewis acids). Accelerators are compounds or chemicals which support crosslinking reactions as ensuring sufficient reaction rate in accordance with the invention. This is accomplished, in particular, catalytically (by activation of the crosslinking reaction) and/or by conversion of functional groups in the crosslinker substances or the macromolecules to be crosslinked into functional groups which are able to react in such a way as to link the macromolecules to one another (bridging, network formation) or via the crosslinker substances to other functional groups.

The accelerators themselves do not participate in a linking reaction of this kind (that is, they do not themselves crosslink), but are able to be incorporated into the network or attached to it, in the form of reaction products or fragments. An accelerator thus ensures a substantial improvement in the reaction kinetics of the crosslinking reaction.

Crosslinkers, in contrast, are substances which are able through their own functional groups to participate in a reaction, more particularly an addition or substitution reaction, which leads to a bridging to the formation of a network. Additionally present may be functional groups which—under the influence mentioned of accelerators or by other processes, for example—are converted in the course of the crosslinking reaction into functional groups which finally lead to bridging between the macromolecules of the polymers to be crosslinked.

Given selected reaction parameters—in accordance with the invention in particular a temperature below the processing temperature of the polymers of the foamed carrier layer—the crosslinking reaction would not proceed, or would only proceed with insufficient rapidity, in the absence of an accelerator. For example, many epoxides which are used as crosslinkers for polyacrylates are inherently relatively slow to react, and so without accelerators do not generate any satisfactory crosslinking outcomes.

Proton donors, especially carboxylic acids and/or carboxylic acid groups and/or protonated derivatives thereof, are not counted as accelerators in the sense of the invention.

The presence of accelerators in the PSAs of the invention does indeed have drawbacks. For instance, nitrogen-containing accelerators in particular such as amines, for example, tend to yellow over time as a result of oxidation processes, meaning that accelerator systems of this kind are poorly suited or unsuited in particular to transparent PSAs or multi-layer pressure-sensitive adhesive tapes which should be used in particular for optical purposes.

Accelerators which are salt-like or which form salts (especially basic accelerators), such as the aforementioned amines or else zinc chloride, for instance, lead to a product of increased moisture reuptake capacity, since salts generally possess hygroscopic properties. Especially for PSAs which are to have very high resistance to combined heat and humidity, in view of the intended sector of use, accelerators of this kind are unsuitable.

In accordance with the invention, therefore, the aim is to achieve thermal crosslinking of the PSAs of the invention, in particular for those that are in air contact with epoxycyclohexyl derivatives without admixing of accelerators. The absence acceleration here relates in particular to externally added accelerators (i.e. accelerators which are not copolymerized and/or incorporated into the polymer framework); with particular preference, however, the PSAs of the invention contain neither externally added nor copolymerized accelerators, in particular no accelerators at all.

The nature of the polymer layers, here in particular of the PSAs of the invention, and their physical properties (for example viscoelasticity, cohesion, elastic component) may be influenced through the nature and the degree of crosslinking thereof.

A PSA of the invention is thus preferably crosslinked by at least one epoxycyclohexyl derivative, more preferably by at least one epoxycyclohexyl carboxylate, especially at least by (3,4-epoxycyclohexane)methyl 3,4-epoxycyclohexylcarboxylate (CAS 2386-87-0).

Epoxycyclohexyl derivates are present in the PSA to be crosslinked, preferably in a total amount of up to 0.4 wt %, very preferably up to 0.3 wt %, based in each case on the total amount of the polymers to be crosslinked. With crosslinker quantities of more than 0.3 part by weight per 100 parts by weight of polymer, detractions from the peel adhesion are increasingly likely, and there is a dramatic deterioration in the wetting. Particularly preferred crosslinker quantities are situated, for example, in the range from 0.12 to 0.30 wt %, more particularly in the range from 0.15 to 0.25 wt %, based in each case on the total amount of the polymers to be crosslinked.

The foamed carrier as well is preferably crosslinked thermally, leading to very homogeneous formation of said layer. With particular preference the foamed carrier is crosslinked thermally by at least one glycidyl ether, more particularly by at least one polyglycidyl ether, more preferably at least by pentaerythritol tetraglycidyl ether (CAS 3126-63-4). Crosslinking of the foamed carrier takes place preferably in combination with an amine, more preferably with isophoronediamine (CAS 2855-13-2), as accelerator. The total fraction of the crosslinkers in the foamed carrier layer for crosslinking is preferably up to 1.0 wt %, more preferably up to 0.8 wt %, based in each case on the total amount of the polymers to be crosslinked. Preferred amounts of crosslinker are situated, for example, in the range from 0.05 to 0.6, more particularly from 0.10 to 0.5, wt %, based in each case on the total amount of the polymers to be crosslinked.

The accelerator is present preferably in an amount from 0.1 to 1.5 wt %, more preferably from 0.15 to 1.2 wt %, based in each case on the total amount of the polymers to be crosslinked.

In the case of three-layer or multi-layer constructions in particular, the presence of an amine accelerator in the foamed carrier is not critical, since in these cases the carrier layer is largely shielded by the external adhesive and/or PSA layers from the influence of oxidizing substances such as atmospheric oxygen, for instance.

Thermal crosslinking of the foamed carrier and of the PSA layer or both layers may be carried out simultaneously, if, for instance, the PSAs are coated onto the as yet uncrosslinked foamed carrier or if the layers are shaped together in a specific process.

However, the individual layers may also be thermally crosslinked in separate processes, if, for instance, the PSAs are coated onto the carrier layer after it has already been thermally crosslinked, and then thermally crosslinked or if the PSAs are shaped at a different location and crosslinked thermally—for instance on a temporary carrier such as a release material, for instance—and then laminated onto the foamed carrier that has already been crosslinked. For this in particular it may be advantageous to carry out chemical and/or physical pretreatment of the foamed carrier and/or of the PSA(s), by means, for example, of corona treatment and/or plasma treatment and/or reactive corona treatment and/or reactive plasma treatment (use of gases such as nitrogen, oxygen, fluorine and/or others) and/or flame treatment.

Double-sided, more particularly three-layer, adhesive tapes of the invention may also be produced as set out for three-layer and multi-layer systems in EP 05 792 143 A1. The production and coating methods described therein may also be employed analogously for the adhesive tapes of the present specification; the disclosure content of EP 05 792 143 A1 is therefore explicitly included in the present disclosure content. The same applies to the description of the product constructions in EP 05 792 143 A1.

Foaming with microballoons in order to produce the foamed carrier is in particular advantageously accomplished in accordance with the processes described in EP 2 414 143 A1 and DE 10 2009 015 233 A1.

The foamed carrier is preferably regarded as a liquid of very high viscosity which under compressive loading exhibits flow behaviour (also referred to as “creeping”). Viscoelastic compositions in this sense preferably have a capacity simply by virtue of the force of gravity, in other words under loading from their intrinsic weight, of flowing more or less slowly and in particular of flowing onto a substrate or of wetting a substrate. At least, however, this effect occurs under an external pressure exposure. Any increase in pressure, by pressing of the adhesive tape onto the substrate, for instance, may significantly accelerate this behaviour.

Viscoelastic materials in the sense of the above-described, preferred foamed carrier further possess the capacity, under slow exposure to force, to relax the forces which act on them. They are therefore capable of dissipating the forces into vibrations and/or deformations, which may also—at least partly—be reversible, and hence of “buffering” the acting forces and of preferably avoiding mechanical destruction by the acting forces, but at least of reducing such destruction or else at least delaying the time of onset of the destruction. In the case of a very fast-acting force, viscoelastic materials customarily exhibit elastic behaviour, in other words the behaviour of a fully reversible deformation, and forces which exceed the elasticity of the material may result in fracture.

In contrast to these are elastic materials, which exhibit the described elastic behaviour even under slow exposure to force. Elastic behaviour, fundamentally, has adverse consequences for the wetting. It is therefore advantageous for the PSAs of the invention as well, in spite of a pronouncedly elastic behaviour, to tend to exhibit viscoelastic behaviour overall under rapid force loading, to behave more viscously like a fluid, in particular over a long time scale, and hence to bring about optimum and—in particular—rapid wetting.

The foamed carrier preferably comprises at least one foaming agent, selected from the group consisting of hollow polymer beads, solid polymer beads, hollow glass beads, solid glass beads, hollow ceramic beads, solid ceramic beads, and solid carbon beads (carbon microballoons). With particular preference the foamed carrier comprises at least partly expanded hollow polymeric microstructures, more particularly those polymeric hollow microstructures which are able to expand from their ground state on supply of heat and/or other energy, such as gas-filled and/or liquid-filled polymer beads whose shell is made, for example, of a thermoplastic material such as polymethyl methacrylate, PVDC or polystyrene. The PSAs of the invention as well may comprise foaming agents of these kinds.

The foamed carrier preferably comprises silica, more preferably precipitated silica surface-modified with dimethyldichlorosilane. This is advantageous since it can be used to adjust the thermal shear strength of the carrier layer, and more particularly to increase it. Silicas, moreover, can be used outstandingly for the transparent carriers. Silica is present preferably at up to 15 wt % in the foamed carrier, based on the entirety of all polymers present in the foamed carrier. The PSAs of the invention as well may comprise silica.

The foamed carrier and/or the PSAs of the invention, more particularly the PSAs of the invention, preferably comprise at least one plasticizer. The plasticizer is preferably selected from the group consisting of (meth)acrylate oligomers, phthalates, cyclohexanedicarboxylic esters (e.g. Hexamoll® DINCH, BASF, CAS 166412-78-8), water-soluble plasticizers, plasticizing resins, phosphates (e.g. Levagard® DMPP, Lanxess, CAS 18755-43-6) and polyphosphates.

Adhesive tapes of the invention, especially double-sided tapes, have a series of advantages generally and in the above-described embodiments:

As a result of the preferred thermal crosslinking, the adhesive tapes have no crosslinking profile through their layers. Viscoelastic layers and/or PSA layers crosslinked by actinic radiation (ultraviolet radiation, electron beams) have a crosslinking profile through the respective crosslinked layer. Thermally crosslinked adhesive layers do not display this feature, since the heat is able to penetrate uniformly into the layer.

PSAs of the invention crosslinked thermally by means of epoxycyclohexyl derivatives have a higher peel adhesion than systems crosslinked by other crosslinkers. This discovery is of significant importance for the adhesive tapes of the invention. If a polyacrylate-based foamed carrier is used and if it is furnished on at least one side with a PSA of the invention, crosslinked thermally, in particular with epoxycyclohexyl derivatives, not only the peel adhesion but also the wetting behaviour on this adhesive tape side are better than for systems
which have the corresponding PSA on an elastic polymer carrier or
which have the same, preferably viscoelastic carrier, but a different PSA, even one which per se is significantly more tacky.

The peel adhesion of an adhesive tape of the invention is influenced not only by the external PSA but also, likewise, by the foamed carrier, meaning that the system as a whole is important for the outstanding adhesive properties. The concept on which the adhesive tapes of the invention are based therefore comprises the combination of a preferably viscoelastic, relatively soft foam layer with a PSA layer which per se (in other words, for example, with elastic film substrates as carriers) is not strongly pressure-sensitively adhesive. This results in the adhesive behaviour on the side of the PSA layer being improved by the interaction of the two layers, leading to peel adhesions and to wetting behaviour which are significantly better than in the case of PSAs which per se have a higher pressure-sensitive adhesiveness, on their own or on elastic carriers.

With the present invention, success has been achieved in qualifying a cohesive PSA having inherently relatively low tack as a PSA for a rapidly wetting adhesive tape with a very high level of peel adhesion, by providing a foam layer bordering this cohesive polymer layer.

In the case of adhesive tapes where the peel adhesion is determined solely by the external PSA, there is often an inevitable compromise between adhesion and cohesion (see introductory part of the present description). Success has been achieved in accordance with the invention in obtaining outstanding overall properties by controlling the properties of two different layers, which can be optimized individually. The peel adhesion of the adhesive tapes of the invention on steel and also on apolar car finishes, in particular, is at least 40 N/cm or more on the side of the PSA of the invention preferably after 12 hours, more preferably after 8 hours. With particular preference this peel adhesion is actually unmeasurable, since a force of more than 50 N/cm leads to desired cohesive splitting of the syntactic polymer foam. The adhesive tapes of the invention, moreover, possess long holding power times at high temperatures (at about 70° C., for example).

For improved handling or storage of the adhesive tapes of the invention, they may be provided on one or else on both sides with a release material, which comprises, for example, silicones, films, siliconized films or papers, surface-treated films or papers, or the like—in other words, what are called liners.

Beyond the layers described so far, the adhesive tapes of the invention may comprise further layers, hence being multi-layer systems having a layer sequence of greater than three. It is especially advantageous if in this case the foamed carrier layer is furnished preferably directly, or at least indirectly, with a PSA layer of the invention, since in that case the above-described technical adhesive advantages are realized.

A feature of the adhesive tapes of the invention is that they can be prepared as very thick products which also possess very high peel adhesion. Such products find application, for example, in the building sector, in the automotive industry, or for adhesive bonds which must compensate unevennesses or cavities.

On account of the good relaxation behaviour of the foamed carrier layer, the adhesive tapes of the invention are suitable for absorbing forces such as mechanical stresses, impacts and the like and of dissipating the energy thereof. The adhesive tapes of the invention are therefore also very highly suitable wherever there is a requirement for an impact-damping and/or vibration-damping effect, as in the bonding, for instance, of fragile articles, in the electronic sector or the like. It is particularly advantageous to deploy the adhesive tapes of the invention if materials having different coefficients of thermal expansion are to be bonded to one another, since the adhesive tapes of the invention, by means of their relaxation capability, are able to dissipate stresses which result from the different expansion behaviour of the interbonded articles or surfaces. On the other hand, in the event that the expansion behaviour of the interbonded articles is very different, conventional adhesive tapes frequently tend to fail—that is, there is a weakening or even a fracture of the bond site.

The adhesive tapes of the invention can be produced in customary thicknesses of adhesive tapes of several to several hundred micrometres, or else particularly advantageously in thicknesses of more than 300 μm, for example 500 μm or more, 1000 μm or more, 1500 μm or more, 2000 μm or more or else 3000 μm or more. Products even thicker can also be realized.

In the case of an adhesive tape of the invention, the foamed carrier preferably has a layer thickness of 300 to 2500 μm, more preferably of 400 to 2400 μm, and the at least one PSA has a layer thickness of 40 to 150 μm, preferably of 50 to 100 μm.

The adhesive tapes of the invention are also especially suitable for the bonding and fastening of decorative trim, emblems and bumpers on apolar automotive surfaces. If required, these surfaces can also be treated with a primer prior to bonding, in order to achieve an even further increase in the strength of bonding.

Further areas of application ideally suited to the adhesive tapes of the invention are, for example, construction or extension of buildings, equipping of buildings and the architectural sector (both inside and/or out) the DIY sector, model construction, furniture making, shipbuilding and aircraft construction, the electronic and electrical industries (for consumer electronics, for example, white goods and brown goods, and red goods as well in view of the high thermal stability) and also for traffic (road signage and the like).

### Experimental Section

### Measurement Methods:

### Solids Content (Method A1):

The solids content is a measure of the fraction of unevaporable constituents in a polymer solution. It is determined gravimetrically, with the solution being weighed, then the vaporizable fractions being evaporated off in a drying cabinet at 120° C. for 2 hours, and the residue weighed again.

### K Value (According to Fikentscher) (Method A2):

The K value is a measure of the average molecule size in high-polymer compounds. For the measurement, one percent strength (1 g/100 ml) toluenic polymer solutions were prepared, and their kinematic viscosities were determined using a Vogel-Ossag viscometer. Following standardization to the viscosity of toluene, the relative viscosity is obtained, and can be used to calculate the K value according to Fikentscher (Polymer 1967, 8, 381 ff.).

### Gel Permeation Chromatography GPC (Method A3):

The figures in this specification for the weight-average molecular weight M_{w} and the polydispersity PD relate to the determination by gel permeation chromatography. The determination takes place on 100 μl samples subjected to clarifying filtration (sample concentration 4 g/1). The eluent used is tetrahydrofuran with 0.1 vol % of trifluoroacetic acid. Measurement takes place at 25° C. The preliminary column used is a PSS-SDV column, 5μ, 10³ Å, ID 8.0 mm×50 mm. Separation takes place using the columns PSS-SDV, 5μ, 10³ Å and also 10⁵ Å and 10⁶ Å, each of ID 8.0 mm×300 mm (columns from Polymer Standards Service; detection using Shodex R171 differential refractometer). The flow rate is 1.0 ml per minute. Calibration takes place against PMMA standards (polymethyl methacrylate calibration).

Density Determination from the Coatweight and the Layer Thickness (Method A4):

The weight per unit volume or density p of a coated self-adhesive composition is determined via the ratio of the weight per unit area to the respective layer thickness:

$$ρ = \frac{m}{V} = \frac{MA}{d} \\ [ ρ ] = \frac{[ kg ]}{[ {m}^{2} ] \cdot [ m ]} = [ \frac{kg}{{m}^{3}} ]$$

MA=coatweight/weight per unit area (excluding liner weight) in [kg/m²]
d=layer thickness (excluding liner thickness) in [m]

This method gives the unadjusted density.

This density determination is suitable in particular for determining the total density of finished products, including multi-layer products.

### 180° Peel Adhesion Test (Method H1):

A strip 20 mm wide of the PSA applied as layer to polyester was applied to steel plates which beforehand had been washed twice with acetone and once with isopropanol. The pressure-sensitive adhesive strip was pressed onto the substrate twice with an applied pressure corresponding to a weight of 2 kg. The adhesive tape was then immediately removed from the substrate with a velocity of 300 mm/min and at an angle of 180°. All measurements were conducted at room temperature.

The results are reported in N/cm and have been averaged from three measurements.

### Holding Power (Method H2):

A strip of the adhesive tape 13 mm wide and more than 20 mm long (30 mm for example) was applied to a smooth steel surface which had been cleaned three times with acetone and once with isopropanol. The bonding area was 20 mm×13 mm (length×width), with the adhesive tape overhanging the test plate (for example by 10 mm in accordance with above-stated length of 30 mm). The adhesive tape was then pressed onto the steel support four times with an applied pressure corresponding to a weight of 2 kg. This sample was suspended vertically, so that the projecting end of the adhesive tape pointed downwards.

At room temperature a weight of e.g. 1 kg (10 N) was affixed to the projecting end of the adhesive tape; the respective weight is given in the examples. Measurement was conducted under standard conditions (23° C., 55% atmospheric humidity) and at 70° C. in a heating cabinet.

The holding powers measured (times which elapse before complete detachment of the adhesive tape from the substrate; measurement discontinued after 10 000 minutes) are reported in minutes and correspond to the average of three measurements.

### Microshear Test (Method H3):

This test is used for accelerated testing of the shear strength of adhesive tapes under temperature load.

### Measurement Sample Preparation for Microshear Test:

An adhesive tape (length about 50 mm, width 10 mm) cut from the respective sample specimen was adhered to a steel test plate, which had been cleaned with acetone, in such a way that the steel plate protruded to the right and left beyond the adhesive tape and the adhesive tape protruded beyond the test plate at the upper edge by 2 mm. The bond area of the sample in terms of height×width=13 mm×10 mm. The bond site was subsequently rolled down six times with a 2 kg steel roller and a speed of 10 m/min. The adhesive tape was reinforced flush with a stable adhesive strip which served as a support for the travel sensor. The sample was suspended vertically by means of the test plate.

### Microshear Test:

The sample specimen for measurement was loaded at the bottom end with a 1000 g weight. The test temperature was 40° C., the test duration 30 minutes (15 minutes of loading and 15 minutes of unloading). The shear travel after the predetermined test duration at constant temperature is reported as the result, in μm, as both the maximum value [“max”; maximum shear travel as a result of 15-minute loading] and as the minimum value [“min”; shear travel (“residual deflection”) 15 minutes after unloading; on unloading there was a movement back as a result of relaxation]. Likewise reported is the elastic component in percent [“elast”; elastic component=(max−min)×100/max].

### 90° Peel Adhesion on Steel—Open and Lined Sides (Method M1):

The peel adhesion on steel was determined under test conditions of 23° C.+/−1° C. temperature and 50%+/−5% relative atmospheric humidity. The specimens were cut to a width of 20 mm and adhered to a steel plate. Prior to the measurement, the steel plate was cleaned and conditioned. This was done by first wiping the plate with acetone and then leaving it to lie in the air for 5 minutes so that the solvent could evaporate.

### Three-Layer Assembly:

The side of the three-layer assembly facing away from the test substrate was then lined with a 50 μm aluminium foil, to prevent the specimen stretching in the course of the measurement. After that, the test specimen was rolled onto the steel substrate. For this purpose, a 2 kg roller was passed five times back and forth over the tape at a rolling speed of 10 m/min. Immediately after rolling, the steel plate was inserted into a special mount which allows the specimen to be peeled off vertically upwards at an angle of 90°. Peel adhesion measurement was carried out using a tensile tester from Zwick. When the lined side was applied to the steel plate, the open side of the three-layer assembly was first laminated to the 50 μm aluminium foil, the release material was removed and the assembly was adhered to the steel plate, rolled analogously, and subjected to measurement.

The results of measurement for both sides, open and lined, are reported in N/cm and have been averaged from three measurements.

### Specimens on 23 μm PET Film:

The single-sided test specimen was applied to the steel substrate and then pressed down five times using a 2 kg roller with a rolling speed of 10 m/min. Immediately after rolling, the steel plate was inserted into a special mount allowing the specimen to be peeled off vertically upwards at an angle of 90°. Peel adhesion was measured using a tensile tester from Zwick. The results are reported in N/cm and are averaged from three measurements.

### Holding Power—Open and Lined Sides (Method M2):

Preparation of specimens was carried out under test conditions of 23° C.+/−1° C. temperature and 50%+/−5% relative atmospheric humidity. The test specimen was cut to 13 mm and adhered to a steel plate. The bonding area was 20 mm×13 mm (length×width). Prior to the measurement the steel plate was cleaned and conditioned. This was done by first wiping the plate with acetone and then leaving it to lie in the air for 5 minutes to allow the solvent to evaporate. After bonding had been performed, the open side was reinforced with a 50 μm aluminium foil and a 2 kg roller was passed twice back and forth over the assembly. A belt loop was then placed on the projecting end of the three-layer assembly. The system was then suspended from a suitable apparatus and loaded with a weight of e.g. 1 kg (10 N); the weight is reported in each of the examples. The suspension apparatus was of a type such that the weight subjects the sample to load at an angle of 179°+/−1°. This ensured that the three-layer assembly could not peel from the bottom edge of the plate. The holding power measured, the time between the specimen being suspended and its fall, is reported in minutes and corresponds to the average from three measurements. For the measurement of the lined side, the open side was first reinforced with the 50 μm aluminium foil, the release material was removed, and the specimen was adhered to the test plate in analogy to the description. The measurement was conducted under standard conditions (23° C., 55% humidity).

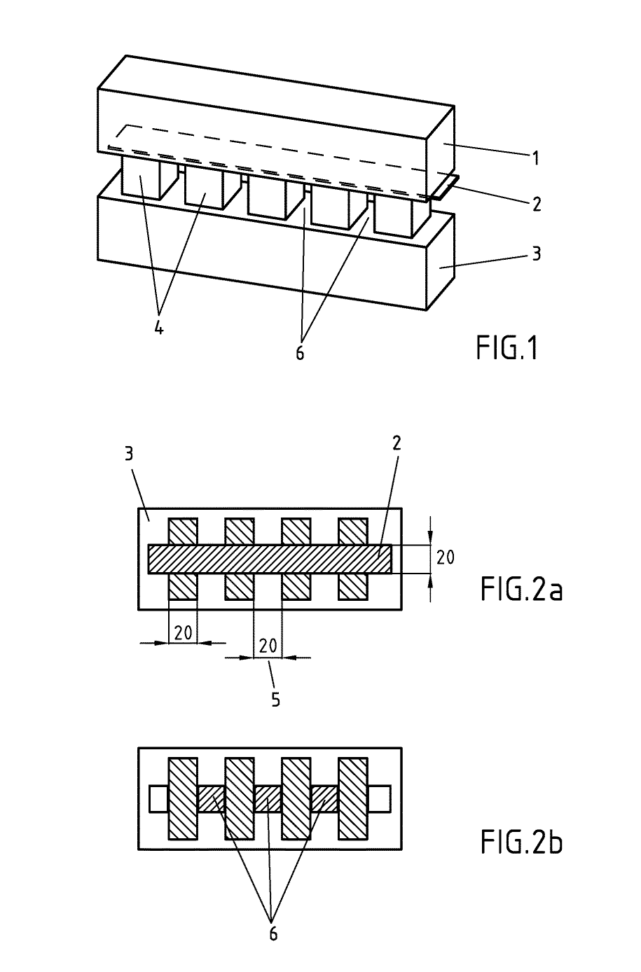

Step Wetting Test with Rigid Substrates/Rigid Rigid Wet-Out Test (Method M3, FIGS. 1, 2a (View from Above) and 2b (View from Below)):

Preparation of specimens took place under test conditions of 23° C.+/−1° C. temperature and 50%+/−5% relative atmospheric humidity. Prior to the measurement, a polycarbonate plate (1, FIG. 1) was cleaned and conditioned. This was done by first wiping the plate with isopropanol and then leaving it to lie in the air for 5 minutes to allow the solvent to evaporate. The test specimen (2, FIGS. 1 and 2a) was cut to a width of 20 mm, adhered centrally to the polycarbonate plate and rolled down five times back and forth with a roller. The weight of the roller was adapted to the width of the test specimen, so that the test specimen was pressed on at 2 kg/cm; for a width of 20 mm, therefore, a 4 kg roller was used. Care was taken to ensure that the test specimen wetted the plate well. Thereafter, bonded specimens were stored for 24 hours under test conditions of 23° C.+/−1° C. temperature and 50%+/−5% relative atmospheric humidity, in order to ensure relaxation of the adhesive tape prior to further processing.

An additional polycarbonate plate (3, FIGS. 1 and 2a) was given adhesively applied steps (4, FIG. 1) with a defined height at a defined spacing (5, FIG. 2a) of 20 mm, and then cleaned and conditioned in accordance with the method described above. Steps with heights of 20 and 100 μm were used and, as a reference, a specimen without steps was measured. The substrate (3, lower layer) with the steps bonded to it was placed on a solid substrate, with the steps pointing upwards, and the substrate (1) provided with the test specimen was placed slowly and evenly, as far as possible without pressure, onto the steps (rigid-rigid application), so that the adhesive tape was not pressed actively into the cavities (6, FIGS. 1 and 2b) between the steps. The assembled plates were subsequently rolled down uniformly once with a roller having a defined weight. The pressing speed of the roller was constant at about 2.4 m/min.

For determining the initial wetting, no step (step height 0 cm) and a 1 kg roller were used. For the step test, a step height of 100 μm and a 4 kg roller were used. In both cases a triplicate determination was carried out. When comparing different adhesive tapes, it was ensured that they had the same thickness.

For both tests, in each case after roller application, a photograph was taken of all areas between the steps (4), with a high resolution and defined illumination in a photo box, for subsequent quantification of the wetted area via a grey stage analysis by image processing software. This was done by image analysis, more specifically via an auto threshold, which utilizes the Otsu analysis. The data delivered is the fraction of the area wetted as a function of time, in [%]. The dewetting, likewise in [%], is calculated from the difference.

### Commercially Available Chemicals Used

| | | Manu- | |
|---|---|---|---|
| Chemical compound | Trade name | facturer | CAS No. |
| Bis(4-tert-butylcyclohexyl) | Perkadox ® 16 | Akzo | 15520- |
| peroxydicarbonate | | Nobel | 11-3 |
| 2,2′-Azobis(2- | Vazo ® 64 | DuPont | 78- |
| methylpropionitrile), AIBN | | | 67-1 |
| Acrylic acid AA (Tg = 106° C.) | — | Sigma- | 79- |
| | | Aldrich | 10-7 |
| Butyl acrylate BA | — | BASF | 141- |
| (iso index 0, Tg = −43° C.) | | | 32-2 |
| 2-Ethylhexyl acrylate EHA | — | BASF | 103- |
| (iso index 1, Tg = −58° C.) | | | 11-7 |
| 2-Propylheptyl acrylate PHA | — | BASF | 149021- |
| (iso index 1, Tg = −69° C.) | | | 58-9 |
| Isodecyl acrylate IDA | — | Sartomer | 1330- |
| (iso index 1, Tg = −60° C.) | | | 61-6 |
| Heptadecanyl acrylate iC17A | — | BASF | — |
| (isomer mixture, iso index 3.1; | | | |
| Tg = −72° C.) | | | |
| Isobornyl acrylate IBOA | Visiomer ® | Evonik | 5888- |
| (Tg = 94° C.) | IBOA | | 33-5 |
| Pentaerythritol | D.E.R. ™ 749 | DOW | 3126- |
| tetraglycidyl ether | | | 63-4 |
| 3,4-Epoxycyclohexylmethyl 3,4- | Uvacure ® | Cytec | 2386- |
| epoxycyclohexanecarboxylate | 1500 | Industries | 87-0 |
| | | Inc. | |
| Isophoronediamine | Vestamin ® | Evonik | 2855- |
| | IPD | | 13-2 |
| Tetraglycidyl-meta- | Erisys ™ GA- | CVC | 63738- |
| xylenediamine | 240 | | 22-7 |
| Resorcinol bis(diphenyl | Reofos ® RDP | Chemtura | 57583- |
| phosphate) | | | 54-7 |
| Microballoons (MB) | Expancel ® | Expancel | |
| (Dry unexpanded microspheres, | 051 DU 40 | Nobel | |
| diameter 9-15 μm, expansion | | Industries | |
| onset temperature 106-111° C., | | | |
| TMA density ≦ 25 kg/m³) | | | |

### I. Preparation of Pressure-Sensitive Adhesives PA1 to PA7

Described below is the preparation of the starting polymers. The polymers investigated are prepared conventionally via a free radical polymerization in solution.

### Polyacrylate PSA 1 (PA1):

A 300 L reactor conventional for radical polymerizations was charged with 11.0 kg of acrylic acid, 27.0 kg of butyl acrylate (BA), 62.0 kg of 2-propylheptyl acrylate (EHA) and 72.4 kg of acetone/isopropanol (94:6). After nitrogen gas had been passed through the reactor for 45 minutes with stirring, the reactor was heated to 58° C. and 50 g of Vazo® 67 were added. The external heating bath was subsequently heated to 75° C. and the reaction was carried out constantly at this external temperature. After a reaction time of 1 hour a further 50 g of Vazo® 67 were added. Dilution took place after 3 hours with 20 kg of acetone/isopropanol (94:6) and after 6 hours with 10.0 kg of acetone/isopropanol (94:6). To reduce the residual initiators, 0.15 kg portions of Perkadox® 16 were added after 5.5 hours and again after 7 hours. The reaction was discontinued after a time of 24 hours and the batch was cooled to room temperature. The polyacrylate was subsequently blended with the crosslinker Uvacure® 1500, and diluted to a solids content of 30% with acetone, and then coated from solution onto a siliconized release film (50 μm polyester) or onto an etched PET film 23 μm thick (coating speed 2.5 m/min, drying tunnel 15 m, temperatures zone 1: 40° C., zone 2: 70° C., zone 3: 95° C., zone 4: 105° C.). The coatweight was 50 g/m². Molar masses by GPC (Method A3): Mₙ=25 000 g/mol; M_{w}=1 010 000 g/mol. K value: 50.3.

### Polyacrylate PSA 1 (PA2):

A 300 L reactor conventional for radical polymerizations was charged with 11.0 kg of acrylic acid, 27.0 kg of BA, 62.0 kg of isodecyl acrylate (IDA) and 72.4 kg of acetone/isopropanol (94:6). After nitrogen gas had been passed through the reactor for 45 minutes with stirring, the reactor was heated to 58° C. and 50 g of Vazo® 67 were added. The external heating bath was subsequently heated to 75° C. and the reaction was carried out constantly at this external temperature. After a reaction time of 1 hour a further 50 g of Vazo® 67 were added. Dilution took place after 3 hours with 20 kg of acetone/isopropanol (94:6) and after 6 hours with 10.0 kg of acetone/isopropanol (94:6). To reduce the residual initiators, 0.15 kg portions of Perkadox® 16 were added after 5.5 hours and again after 7 hours. The reaction was discontinued after a time of 24 hours and the batch was cooled to room temperature. The polyacrylate was subsequently blended with the crosslinker Uvacure® 1500, diluted to a solids content of 30% with acetone and then coated and dried analogously to PA1. The coatweight was 50 g/m². Molar masses by GPC (Method A3): Mₙ=31 400 g/mol; M_{w}=961 000 g/mol. K value: 49.4.

### Polyacrylate PSA 3 (PA3):

A 100 L glass reactor conventional for radical polymerizations was charged with 4.0 kg of acrylic acid, 12.0 kg of BA, 24.0 kg of PHA and 26.7 kg of acetone/benzine 60/95 (1:1). After nitrogen gas had been passed through the reactor for 45 minutes with stirring, the reactor was heated to 58° C. and 30 g of AIBN were added. The external heating bath was subsequently heated to 75° C. and the reaction was carried out constantly at this external temperature. After a reaction time of 1 hour a further 30 g of AIBN were added. Dilution was carried out after 4 hours and after 8 hours, in each case with 10.0 kg of acetone/benzine 60/95 (1:1) mixture. To reduce the residual initiators, 90 g portions of Perkadox® 16 were added after 8 hours and again after 10 hours. The reaction was discontinued after a time of 24 hours and the batch was cooled to room temperature. The polyacrylate was subsequently blended with the crosslinker Uvacure® 1500, diluted to a solids content of 30% with acetone and then coated and dried analogously to PA1. The coatweight was 50 g/m². Molar masses by GPC (Method A3): Mₙ=24 500 g/mol; M_{w}=871 000 g/mol. K value: 48.2.

### Polyacrylate PSA 4 (PA4):

A 100 L glass reactor conventional for radical polymerizations was charged with 3.2 kg of acrylic acid, 8.0 kg of BA, 28.8 kg of IDA and 26.7 kg of acetone/isopropanol (94:6). After nitrogen gas had been passed through the reactor for 45 minutes with stirring, the reactor was heated to 58° C. and 30 g of Vazo® 67 were added. The external heating bath was subsequently heated to 75° C. and the reaction was carried out constantly at this external temperature. After a reaction time of 1 hour a further 30 g of Vazo® 67 were added. Dilution was carried out after 4 hours and after 8 hours, in each case with 10.0 kg of acetone/isopropanol (94:6) mixture. To reduce the residual initiators, 90 g portions of Perkadox® 16 were added after 8 hours and again after 10 hours. The reaction was discontinued after a time of 24 hours and the batch was cooled to room temperature. The polyacrylate was subsequently blended with the crosslinker Uvacure® 1500, diluted to a solids content of 30% with acetone, and then coated and dried analogously to PA1. The coatweight was 50 g/m². Molar masses by GPC (Method A3): Mₙ=35 000 g/mol; M_{w}=1 020 000 g/mol. K value: 52.9.

### Comparative Example—Polyacrylate PSA 5 (PA5, Monomer EHA with Iso Index of 1 and Tg>−60° C.)

A 100 L glass reactor conventional for radical polymerizations was charged with 4.0 kg of acrylic acid, 12.0 kg of BA, 24.0 kg of EHA and 26.7 kg of acetone/benzine 60/95 (1:1). After nitrogen gas had been passed through the reactor for 45 minutes with stirring, the reactor was heated to 58° C. and 30 g of AIBN were added. The external heating bath was subsequently heated to 75° C. and the reaction was carried out constantly at this external temperature. After a reaction time of 1 hour a further 30 g of AIBN were added. Dilution was carried out after 4 hours and after 8 hours, in each case with 10.0 kg of acetone/benzine 60/95 (1:1) mixture. To reduce the residual initiators, 90 g portions of Perkadox® 16 were added after 8 hours and again after 10 hours. The reaction was discontinued after a time of 24 hours and the batch was cooled to room temperature. The polyacrylate was subsequently blended with the crosslinker Uvacure® 1500, diluted to a solids content of 30% with acetone, and then coated and dried analogously to PA1. The coatweight was 50 g/m². Molar masses by GPC (Method A3): Mₙ=26 800 g/mol; M_{w}=809 000 g/mol. K value: 46.3.

### Comparative Example—Polyacrylate PSA 6 (PA6, Monomer PHA and IBOA (Cyclic Monomer))

A 100 L glass reactor conventional for radical polymerizations was charged with 2.4 kg of acrylic acid, 12.0 kg of isobornyl acrylate (IBOA), 25.6 kg of PHA and 26.7 kg of acetone/benzine 60/95 (1:1). After nitrogen gas had been passed through the reactor for 45 minutes with stirring, the reactor was heated to 58° C. and 30 g of AIBN were added. The external heating bath was subsequently heated to 75° C. and the reaction was carried out constantly at this external temperature. After a reaction time of 1 hour a further 30 g of AIBN were added. Dilution was carried out after 4 hours and after 8 hours, in each case with 10.0 kg of acetone/benzine 60/95 (1:1) mixture. To reduce the residual initiators, 90 g portions of bis(4-tert-butylcyclohexyl) peroxydicarbonate were added after 8 hours and again after 10 hours. The reaction was discontinued after a time of 24 hours and the batch was cooled to room temperature. The polyacrylate was subsequently blended with the crosslinker Uvacure® 1500, diluted to a solids content of 30% with acetone, and then coated and dried analogously to PA1. The coatweight was 50 g/m². Molar masses by GPC (Method A3): Mₙ=24 800 g/mol; M_{w}=980 000 g/mol. K value: 50.1.

### Comparative Example—Polyacrylate PSA 7 (PA7, Monomer iC17A with Iso Index of 3.1 and Tg<−60° C.)

A 100 L glass reactor conventional for radical polymerizations was charged with 11.0 kg of acrylic acid, 27.0 kg of BA, 62.0 kg of heptadecanyl acrylate (iC17A) and 72.4 kg of acetone/isopropanol (94:6). After nitrogen gas had been passed through the reactor for 45 minutes with stirring, the reactor was heated to 58° C. and 50 g of Vazo® 67 were added. The external heating bath was subsequently heated to 75° C. and the reaction was carried out constantly at this external temperature. After a reaction time of 1 hour a further 50 g of Vazo® 67 were added. Dilution was carried out after 3 hours of 20 kg of acetone/isopropanol (94:6) and after 6 hours with 10.0 kg of acetone/isopropanol (94:6). To reduce the residual initiators, 0.15 kg portions of Perkadox® 16 were added after 5.5 hours and again after 7 hours. The reaction was discontinued after a time of 24 hours and the batch was cooled to room temperature. The polyacrylate was subsequently blended with the crosslinker Uvacure® 1500, diluted to a solids content of 30% with acetone, and then coated and dried analogously to PA1. The coatweight was 50 g/m². (coating speed 2.5 m/min, drying tunnel 15 m, temperatures zone 1: 40° C., zone 2: 70° C., zone 3: 95° C., zone 4: 105° C.) The coatweight was 50 g/m². Molar masses by GPC (Method A3): Mₙ=27 000 g/mol; M_{w}=990 000 g/mol. K value: 50.1.

For the measurement of the technical adhesive properties of the PSAs, first of all the adhesives PA1-PA7 specified in the examples were tested, without the polyacrylate foam carrier and with the crosslinker Uvacure® 1500 and, in one comparative example, with a glycidyl-functionalized crosslinker (Erisys GA-240). From the results in Table 1 it is apparent that in the case both of Examples B1-B5 of the inventive PSAs PA1-PA4 and in the comparative examples VB6-VB9 of the comparative PSAs PA5-PA7, the adhesives are very cohesive and have a moderate peel adhesion on steel. Crosslinking of the PSA PA1 (Example 5) by means of a glycidyl amine likewise shows good results.

TABLE 1
Examples B1-B5 and Comparative Examples VB6-VB10 - Technical
adhesive date of the PSAs

| | | | Peel | Peel | | HP. | | |
|---|---|---|---|---|---|---|---|---|
| | | | adhesion | adhesion | HP, 10 N, | 10 N, | MST | Elast. |
| | | Crosslinker | on steel | on PE | 23° C. | 70° C. | max | Components |
| Ex. | PA | [wt %] | [N/cm] | [N/cm] | [min] | [min] | [μm] | [%] |
| B1 | PA1 | Uvacure, | 5.7 | 0.9 | >10 000 | 1180 | 532 | 92 |
| | | 0.18 | | | | | | |
| B2 | PA1 | Uvacure, | 5.4 | 0.8 | >10 000 | 2500 | 420 | 93 |
| | | 0.22 | | | | | | |
| B3 | PA2 | Uvacure, | 5.8 | 1.0 | >10 000 | 2200 | 470 | 95 |
| | | 0.20 | | | | | | |
| B4 | PA3 | Uvacure, | 6.3 | 0.9 | >10 000 | 2510 | 416 | 97 |
| | | 0.20 | | | | | | |
| B5 | PA1 | Erisys, | 5.1 | 0.8 | >10 000 | 2900 | 120 | 95 |
| | | 0.075 | | | | | | |
| B6 | PA4 | Uvacure, | 6.3 | 0.8 | >10 000 | 1750 | 450 | 92 |
| | | 0.20 | | | | | | |
| VB7 | PA5 | Uvacure, | 4.9 | 1.0 | >10 000 | 440 | 297 | 97 |
| | | 0.18 | | | | | | |
| VB8 | PAS | Uvacure, | 5.2 | 0.8 | >10 000 | 2200 | 350 | 94 |
| | | 0.22 | | | | | | |
| VB9 | PA6 | Uvacure, | 5.4 | 1.2 | >10 000 | 3100 | 420 | 89 |
| | | 0.20 | | | | | | |
| VB10 | PA7 | Uvacure, | 2.8 | 1.5 | >10 000 | 25 | 390 | 91 |
| | | 0.20 | | | | | | |

Peel adhesion on steel and PE = Method H1,
HP = Holding power times 23° and 70° C. = Method H2,
MST = Microshear test = Method H3,
Elast. component = Elastic component

### II Preparation of the Starting Polymers for the Polyacrylate Foam VT and for PSA Tape Examples MT1 to MT15

Described below is the preparation of the starting polymer, which was prepared conventionally via free radical polymerization in solution.

### Base Polymer P

A reactor conventional for radical polymerizations was charged with 30 kg of EHA, 67 kg of BA, 3 kg of acrylic acid and 66 kg of acetone/isopropanol (96:4). After nitrogen gas had been passed through the reactor for 45 minutes, with stirring, the reactor was heated to 58° C. and 50 g of Vazo® 67 were added. Thereafter the external heating bath was heated to 75° C. and the reaction was carried out constantly at this external temperature. After 1 hour a further 50 g of Vazo® 67 were added and after 4 hours the batch was diluted with 20 kg of acetone/isopropanol mixture (96:4). After 5 hours and again after 7 hours, re-initiation took place with 150 g of Perkadox® 16 each time, followed by dilution with 23 kg of acetone/isopropanol mixture (96:4). After a reaction time of 22 hours, the polymerization was discontinued and the batch was cooled to room temperature. The polyacrylate has a K value of 75.1, a solids content of 50.2% and average molecular weights of Mₙ=91 900 g/mol and M_{w}=1 480 000 g/mol.

### Process 1: Concentration/Preparation of Hotmelt PSAs:

The base polymer P is very largely freed from the solvent by means of a single-screw extruder (concentrating extruder, Berstorff GmbH, Germany) (residual solvent content 0.3 wt %). The parameters for the concentration of the base polymer were as follows:

the screw speed was 150 rpm, the motor current 15 A, and a throughput of 58.0 kg liquid/h was realized. For concentration, a vacuum was applied at three different domes. The reduced pressures were, respectively, between 20 mbar and 300 mbar. The exit temperature of the concentrated hotmelt P was approximately 115° C. The solids content after this concentration step was 99.8%.
Process 2: Preparation of Inventive Adhesive Tapes, Blending with the Crosslinker-Accelerator System for Thermal Crosslinking, and Coating

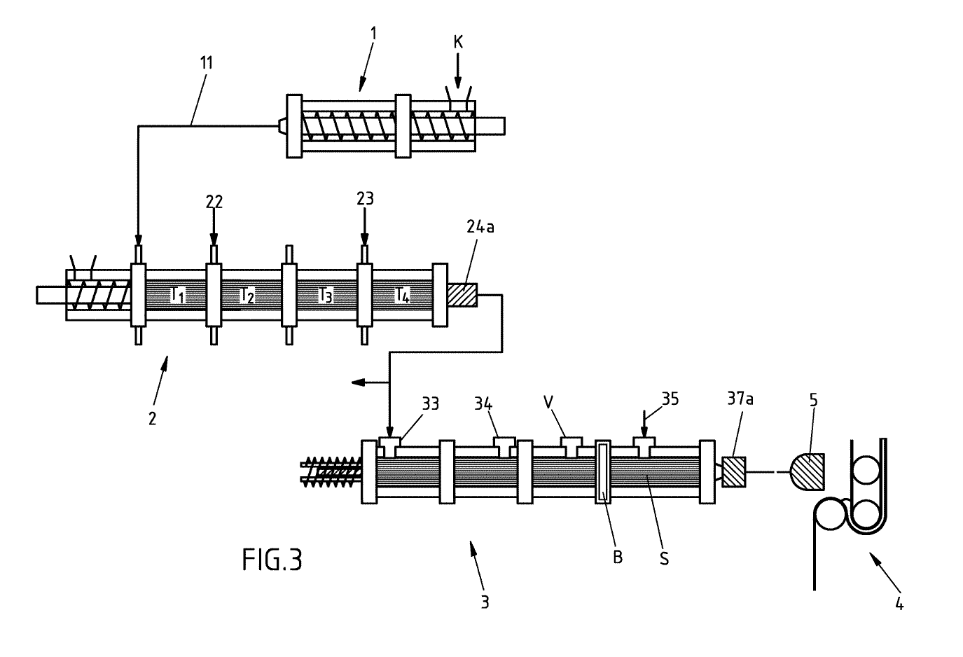

Foaming took place in an experimental unit which corresponds to the illustration in FIG. 3.

The base polymer P was melted by process 1 in a feeder extruder 1 and conveyed as a polymer melt via a heatable hose 11 into a planetary roller extruder 2 (PRE) from ENTEX (Bochum) the PRE used in particular had four modules T1, T2, T3, T4, heatable independently of one another). Via the metering port 22 it was possible to supply additional additives or fillers, such as colour pastes, for example. At point 23 the crosslinker was added. All of the components were mixed to form a homogeneous polymer melt.

By means of a melt pump 24a and a heatable hose 24b, the polymer melt was transferred to a twin-screw extruder 3 (from BERSTORFF) (feed position 33). At position 34, the accelerator component was added. Subsequently the mixture as a whole was freed from all gas inclusions in a vacuum dome V at a pressure of 175 mbar. Downstream of the vacuum zone, on the screw, there was a blister B, which allowed a build-up of pressure in the subsequent segment S. Through appropriate control of the extruder speed and of the melt pump 37a, a pressure of greater than 8 bar was built up in the segment S between blister B and melt pump 37a. At the metering point 35 the microballoon mixture (microballoons embedded into the dispersing assistant in accordance with the details given for the experimental series) was added, and was incorporated homogeneously into the premix by means of a mixing element. The resultant melt mixture was transferred into a die 5.

Following departure from the die 5, in other words after a drop in pressure, the incorporated microballoons underwent expansion, with the drop in pressure resulting in a low-shear cooling of the polymer composition. This produced a foamed carrier material. This carrier material was subsequently coated on both sides with the PSAs set out below, each of which was supplied on a release material which can be used again after being removed (in-process liner). The resulting three-layer assembly was shaped to a web by means of a roll calender 4.

In order to improve the anchoring of the PSAs from examples B1-10 on the shaped polyacrylate foam, not only the PSAs but also the foam were pretreated by corona (corona unit from VITAPHONE, Denmark, 70 W min/m²). After the production of the three-layer assembly, said treatment produced improved chemical attachment to the polyacrylate foam carrier layer.

The belt speed on the passage through the coating unit was 30 m/min.

Downstream of the roll nip, a release material was removed and the completed three-layer product was wound with the remaining, second release material.

TABLE 2
Polyacrylate foam VT

| Example | | | | VT |
|---|---|---|---|---|
| Compo- | Base polymer P | | [wt %] | 97.8 |
| nents | Expancel 051 DU 40 | | | 1.5 |
| | Polypox R16 | | | 0.139 |
| | IPDA | | | 0.144 |
| | Reofos RDP | | | 0.41 |
| Con- | Thickness | | [μm] | 902 |
| struction | Density | | [kg/m³] | 749 |
| Technical | HP [min] | RT 20N | [min] | 1874 |
| adhesive | | 70° C. 10N | | 1282 |
| properties | Peel adhesion | instantaneous | [N/cm] | 24.5 A |
| | on steel | 3 d | | 33.4 A |
| | [N/cm] | 14 d | | 35.1 A |

Density: Method A4,
Peel adhesion: Method H2,
HP (Holding power): Method M2

Presented below are concrete examples B1-B6 of the inventive adhesive tapes, comprising the polyacrylate foam carrier VT with the inventive PSAs with a double-sided coatweight of 50 g/m², and comparative examples VB7-VB10, comprising the polyacrylate foam carrier VT with the noninventive PSAs, likewise with a double-sided coatweight of 50 g/m².

TABLE 3
Peel adhesions on steel and PE and also peel increase of the three-layer
PSA tapes MT1-MT10 comprising the polyacrylate foam carrier VT with a total
thickness of 1000 μm

| | | | | Peel | Peel | Peel | Peel |
|---|---|---|---|---|---|---|---|
| | | Peel adhesion on | | adhesion | adhesion | adhesion | adhesion |
| | | steel, | | on steel, | on steel, | on steel, | on PE, |
| | | instantaneous | | 8 h, | 1 d, | 3 d, | 3 d, |
| | | [N/cm] | | [N/cm] | [N/cm] | [N/cm] | [N/cm] |
| | | open | | open | open | open | open |
| Ex. | PSA | side | lined side | side | side | side | side |
| MT1 | B1 | 11.1 | 12.0 | 44 f.s. | 44 f.s. | 45 f.s. | 10.1 |
| MT2 | B2 | 16.3 | 15.1 | 44 f.s. | 44 f.s. | 46 f.s. | 10.3 |
| MT3 | B3 | 11.5 | 10.1 | 45 f.s. | 45 f.s. | 44 f.s. | 12.6 |
| MT4 | B4 | 15.2 | 15.9 | 45 f.s. | 45 f.s. | 45 f.s. | 11.4 |
| MT5 | B5 | 12.0 | 12.1 | 44 f.s. | 45 f.s. | 46 f.s. | 10.9 |
| MT6 | B6 | 12.2 | 11.6 | 45 f.s. | 45 f.s. | 46 f.s. | 10.5 |
| MT7 | VB7 | 11.9 | 12.6 | 38.2 | 42.6 | 47 f.s. | 11.2 |
| MT8 | VB8 | 14.1 | 15.1 | 40.1 | 45 f.s. | 45 f.s. | 12.7 |
| MT9 | VB9 | 10.7 | 9.9 | 22.9 | 38.7 | 45 f.s. | 12.6 |
| MT10 | VB10 | 9.8 | 9.8 | 15.4 | 22.2 | 25.4 | 8.0 |
| MT1 | B1 | 11.1 | 12.0 | 44 f.s. | 44 f.s. | 45 f.s. | 10.1 |
| MT2 | B2 | 16.3 | 15.1 | 44 f.s. | 44 f.s. | 46 f.s. | 10.3 |
| MT3 | B3 | 11.5 | 10.1 | 45 f.s. | 45 f.s. | 44 f.s. | 12.6 |
| MT4 | B4 | 15.2 | 15.9 | 45 f.s. | 45 f.s. | 45 f.s. | 11.4 |

PSA = pressure-sensitive adhesive, peel adhesion on steel = Method M1 (f.s. = foam split) Holding power = Method M2

From the peel adhesion measurements in Table 3 it is apparent that the inventive PSA tapes MT1-MT6 adhere much more quickly to steel and retain their maximum peel adhesion and/or that with them the splitting of the polyacrylate foam carrier occurs more quickly. Striking, for example, is the PSA VB9 in Example MT9, which as well as the inventively used monomer PHA uses a cyclic acrylate with a high Tg instead of a linear monomer. Here it is found that the polymer takes much longer to adhere to the substrate. Additionally striking is the PSA VB10, whose peel adhesion on steel in combination with the polyacrylate foam carrier is much lower even after three days. Apart from the latter example, all of the PSA tapes have comparable peel adhesions on PE. The effect of the crosslinker is evident, furthermore, in Example MT5. The use of a glycidyl-functionalized rather than an epoxycyclohexyl-functionalized crosslinker leads to slower peel increase.

Table 4 lists the peel adhesions on the different low-energy car finishes UreGloss, CeramiClear5 (CC5) and VW2K after an adherence time of three days.

TABLE 4
Peel adhesions on low-energy finishes of the three-
layer PSA tapes MT1-MT10 comprising the polyacrylate
foam carrier VT with a total thickness of 1000 μm

| | | Peel adhesion | Peel adhesion | Peel adhesion |
|---|---|---|---|---|
| | | on UreGloss, 3 d, | on CC5 3 d, | on VW2K 3 d, |
| | | [N/cm] | [N/cm] | [N/cm] |
| Ex. | PSA | open side | open side | open side |
| MT1 | B1 | 16.6 | 23.8 | 44 f.s. |
| MT2 | B2 | 16.9 | 24.7 | 46 f.s. |
| MT3 | B3 | 19.1 | 25.9 | 46 f.s. |
| MT4 | B4 | 16.7 | 24.0 | 45 f.s. |
| MT5 | B5 | 16.1 | 21.5 | 44 f.s. |
| MT6 | B6 | 19.2 | 24.3 | 45 f.s. |
| MT7 | VB7 | 14.3 | 22.8 | 38.5 |
| MT8 | VB8 | 14.6 | 25.1 | 34.2 |
| MT9 | VB9 | 12.2 | 21.5 | 31.7 |
| MT10 | VB10 | 10.1 | 12.5 | 20.4 |

Here as well it is apparent that the PSA tapes comprising the inventive PSAs, in comparison, provide better results.

TABLE 5
Rigid Rigid Wet-out Test of the three-layer PSA
tapes MT1-MT10 comprising the polyacrylate foam
carrier VT with a total thickness of 1000 μm

| | | | | | Dewetting |
|---|---|---|---|---|---|
| | Wetting | Wetting | | | 100 μm, |
| | 0 μm, | 100 μm, | Wetting | Wetting | 4 kg, dif- |
| | 1 kg, | 4 kg, | 100 μm, | 100 μm, | ference 3 d − |
| | instanta- | instanta- | 4 kg, 1 | 4 kg, 3 | instanta- |
| | neous, [%] | neous, [%] | d, [%] | d, [%] | neous, [%] |
| Ex. | open side | open side | open side | open side | open side |
| MT1 | 98 | 93 | 90 | 69 | −24 |
| MT2 | 96 | 90 | 85 | 73 | −17 |
| MT3 | 97 | 87 | 82 | 72 | −15 |
| MT4 | 98 | 90 | 86 | 68 | −22 |
| MT5 | 98 | 85 | 55 | 42 | −33 |
| MT6 | 97 | 85 | 79 | 69 | −16 |
| MT7 | 98 | 86 | 53 | 12 | −74 |
| MT8 | 97 | 88 | 49 | 9 | −77 |
| MT9 | 96 | 69 | 42 | 22 | −47 |
| MT10 | 98 | 82 | 12 | 6 | −76 |

The difference between the inventive PSA tapes and the comparative examples is most apparent in the Rigid Rigid Wet-out Test. Whereas in the case of the bond without a step, the wetting is very good in all the examples, it is evident that when using a step height of 100 μm, the instantaneous wetting is good only when utilizing the inventive PSAs MT1-MT6. Clearly in evidence here as well is the effect of the monomer, particularly of the cyclic acrylate in Ex. MT9, and also of the crosslinker (MT5). It is apparent, furthermore, that the dewetting, here reported as the difference between the wetting after three days and instantaneously (the smaller the difference, the less the dewetting), is likewise at its least in the case of the inventive examples.

1. Pressure-sensitive adhesive comprising at least 50 wt %, based on the total weight of the pressure-sensitive adhesive, of at least one polymer A which is derived from the following monomer composition:
a1) 55 to 75 wt % of at least one (meth)acrylic ester having a homopolymer glass transition temperature of not more than −60° C. and an alcohol component based on a branched, primary alcohol, having an iso index of 1;
a2) 20 to 40 wt % of at least one (meth)acrylic ester having an alcohol component based on a linear C₁-C₁₈ alcohol;
a3) 5 to 15 wt % of acrylic acid.

2. Pressure-sensitive adhesive according to claim 1, wherein the pressure-sensitive adhesive is thermally crosslinked by at least one epoxycyclohexyl derivative.

3. Pressure-sensitive adhesive according to claim 1, wherein the pressure-sensitive adhesive comprises no peel adhesion-boosting resin.

4. Pressure-sensitive adhesive according to claim 1, wherein the polymer A has a weight-average molecular weight M_{w} of at least 500 000 g/mol.

5. Pressure-sensitive adhesive according to claim 1, wherein the polymer A has a weight-average molecular weight M_{w} of not more than 1 700 000 g/mol.

6. Adhesive tape comprising a foamed carrier and a pressure-sensitive adhesive according to claim 1.

7. Adhesive tape according to claim 6, wherein the foamed carrier comprises a syntactic polymer foam.

8. Adhesive tape according to claim 7, wherein the syntactic polymer foam comprises at least 50 wt %, based on the total weight of the foam, of one or more poly(meth)acrylates.

9. Adhesive tape according to claim 6, wherein the pressure-sensitive adhesive is laminated on at least one side of the foamed carrier.

10. Adhesive tape according to claim 6, wherein the foamed carrier comprises at least 50 wt %, based on the total weight of the foam, of at least one poly(meth)acrylate B which can be traced back to the following monomer composition:
b1) 65 to 97 wt % of ethylhexyl acrylate and/or butyl acrylate,
b2) 0 to 30 wt % of methyl acrylate,
b3) 3 to 15 wt % of acrylic acid.

11. Adhesive tape according to claim 6, wherein the foamed carrier is thermally crosslinked.

12. Adhesive tape according to claim 6, wherein the pressure-sensitive adhesive is applied to both sides of the foamed carrier.

13. A method of providing rapid wetting of surfaces having different surface energies, said method comprising adhering an adhesive tape according to claim 6 to said surfaces.
